(19) United States
(12) Patent Application Publication
(10) Pub. No.: US 2022/0146085 A1
(43) Pub. Date: May 12, 2022

(54) LIGHTING DEVICE WITH A SILENT LARGE-VOLUME AIR DUCT STRUCTURE

(71) Applicant: FOSHAN QAIR TECHNOLOGY CO, LTD., Foshan (CN)

(72) Inventors: SHUN ZHAO, Foshan (CN); HAO JUN YU, Foshan (CN)

(21) Appl. No.: 17/584,201

(22) Filed: Jan. 25, 2022

Related U.S. Application Data
(63) Continuation of application No. PCT/CN2019/111546, filed on Oct. 17, 2019.

(30) Foreign Application Priority Data
Aug. 9, 2019 (CN) 201910734575.9

(51) Int. Cl. F21V 29/83; F21V 29/67; F21V 33/00

(52) U.S. Cl. CPC F21V 29/83; F21W 2131/30; F21V 33/0044; F21V 29/673

(57) ABSTRACT

The application discloses a lighting device with a silent large-volume air duct structure, which comprises an outer shell and an inner shell. The inner shell is embedded and installed on the end face of the outer shell, and a gap between the outer periphery of the inner shell and the inner side of the outer shell forms an air outlet duct. The outer shell or the inner shell is also provided with an air inlet, and an air suction part is arranged corresponding to the air inlet. The cross-sectional shape of the air outlet duct includes an acceleration air duct whose width gradually decreases from inner to outer, and a trumpet-shaped opening connected at the end of the acceleration air duct and connected with the outside, and its technical scheme overcomes the problems in the existing technology that the fan lamp is large in size and generates noise, etc.

### CROSS-REFERENCE TO RELATED APPLICATIONS

This application is a U.S. continuation of co-pending International Patent Application Number PCT/CN2019/111546, filed on Oct. 17, 2019, which claims the benefit and priority of Chinese Patent Application No. 201910734575.9 entitled “USE OF HORDENINE IN PREPARING DRUGS FOR TREATING PITUITARY TUMORS”, filed before China National Intellectual Property Administration on Aug. 9, 2019, the entire contents of which are incorporated herein by reference.

### TECHNICAL FIELD

The invention belongs to the technical field of lighting fixtures, and particularly relates to a lighting device with a silent large-volume air duct structure.

### BACKGROUND

Lamps include pendant lamps, ceiling lamps, wall lamps, floor lamps, table lamps, etc. It refers to the apparatus that can transmit light, distribute and change the light distribution of light source. As a necessity for people's life lighting, it is essential for every household.

At present, in order to save space, there is a form of combining fans with pendant lamps, so that they can be used as lamps for lighting as well as fans. However, this kind of fan lamp is generally larger in size and difficult to clean because of the need to set fan blades and to reserve the installation and movement space of fan blades. Moreover, setting large fan blades will inevitably generate noise when starting;

In addition, there is no fan cover on the lamps, so the fan lamp can only be used on the pendant lamps, while other lamps such as wall lamps and ceiling lamps can't be combined with the fan structure.

### SUMMARY

In order to solve the problem that the fan lamp is large in size and generates noise in the existing technology, the invention provides a lighting device with a silent large-volume air duct structure.

The invention is realized by the following technical scheme:

A lighting device with a silent large-volume air duct structure comprises an outer shell and an inner shell, wherein a light emitting part is arranged on the outer shell or the inner shell. The inner shell is embedded and installed on the end face of the outer shell, and the gap between the outer periphery of the inner shell and the inner side of the outer shell forms an air outlet duct. The outer shell or the inner shell is also provided with an air inlet which is connected with the air outlet duct, and an air suction part is arranged corresponding to the air inlet. The cross-sectional shape of the air outlet duct includes an acceleration air duct whose width gradually decreases from inner to outer, and a trumpet-shaped opening connected at the end of the acceleration air duct and connected with the outside.

As for the above-mentioned lighting device with a silent large-volume air duct structure, the trumpet-shaped opening is arranged at an included angle with the acceleration air duct.

As for the above-mentioned lighting device with a silent large-volume air duct structure, the included angle between the trumpet-shaped opening and the acceleration air duct is 150° to 170°.

As for the above-mentioned lighting device with a silent large-volume air duct structure, the width of the acceleration air duct satisfies d=D−0.13 L;

Where, d is the width of the end of the acceleration air duct, D is the maximum width of the beginning of the acceleration air duct, and L is the length from the beginning to the end of the acceleration air duct.

As for the above-mentioned lighting device with a silent large-volume air duct structure, the maximum width D of the beginning of the acceleration air duct is 3˜6 mm.

As for the above-mentioned lighting device with a silent large-volume air duct structure, the length L of the acceleration air duct is 10˜20 mm.

As for the above-mentioned lighting device with a silent large-volume air duct structure, the light emitting part is installed in the inner shell; Or the light emitting part is installed on the outer wall of the outer shell.

As for the above-mentioned lighting device with a silent large-volume air duct structure, the lower end face of the outer shell is provided with an upward concave inner cavity, the inner shell is arranged in the inner cavity, the lower end of the inner shell is also provided with an upward concave cavity, and the light emitting part is arranged in the concave cavity, and the light emitting part comprises a light emitting unit arranged in the concave cavity and a light guide plate covering the lower end opening of the concave cavity.

As for the above-mentioned lighting device with a silent large-volume air duct structure, the air inlet is arranged in the middle of the inner shell and connected with the inner cavity of the outer shell; Or the air inlet is arranged in the middle of the outer shell and connected with the inner cavity of the outer shell.

As for the above-mentioned lighting device with a silent large-volume air duct structure, the air suction part comprises an air suction fan arranged in the air inlet, and the air suction fan comprises a blade base and a plurality of blades uniformly distributed on the blade base in a circumferential manner, and the included angle α between the blade tip and the central axis of the blade base is 33.5°˜37.3°, and the included angle β between the blade root and the central axis of the blade base is 52°˜58°.

As for the above-mentioned lighting device with a silent large-volume air duct structure, the upper end face of the outer shell is also provided with a mounting part, and the mounting part is connected with a mounting seat for fixedly connecting to the outside, and the mounting seat is detachably connected to the mounting part.

As for the above-mentioned lighting device with a silent large-volume air duct structure, the air inlet is provided with a dust-proof cover.

Compared with the existing technology, the invention has the following advantages:

1. The invention provides a lighting device with a silent large-volume air duct structure. By integrating the structure of a bladeless fan into the inner shell, it not only has the lighting function, but also meets the demand of air blowing, and at the same time, it also solves the problems that the fan lamp is large in size and easy to generate noise. Moreover, this product is not limited to be used in pendant lamps, can be used as wall lamps, ceiling lamps and other lamps, and can replace fans in more occasions.

2. In the invention, the air outlet duct is optimized, and the air blown out through the acceleration duct and the trumpet-shaped opening has the characteristics of large air volume, wide angle and silence, which meets the needs of users.

3. The invention has the special design of the suction fan structure of the lighting device with a silent large-volume air duct structure, which makes the blade design have the characteristics of small volume, light weight, high efficiency and large air flow at the blade compared with the traditional fan blade design under the condition of the same size and the same electric power rate input.

### BRIEF DESCRIPTION OF DRAWINGS

In order to more clearly describe the technical scheme in the Embodiments of the invention, the attached drawings used in the description of the Embodiments will be briefly introduced as follows. Obviously, the attached drawings in the following description are only some Embodiments of the invention, and for ordinary technicians in the field, other drawings can be obtained according to these drawings without making creative efforts.

FIG. 1 and FIG. 2 are structural schematic drawings of Embodiment 1 of the invention from different perspectives;

FIG. 3 and FIG. 4 are structural explosion drawings of Embodiment 1 of the invention from different perspectives;

FIG. 5 is a sectional drawing of A-A′ in FIG. 2;

FIG. 6 is a Part A′s enlarged drawing of FIG. 5;

FIG. 7 is a structural schematic drawing of suction fan.

FIG. 8 is a structural schematic drawing of Embodiment 2;

FIG. 9 is a structural explosion drawing of Embodiment 2;

FIG. 10 is a front drawing of Embodiment 2;

FIG. 11 is a structural schematic drawing of Embodiment 3.

### DETAILED DESCRIPTION

In order to make the technical problems, technical schemes and beneficial effects solved by the invention clearer, the invention will be further described in detail below with reference to the attached drawings and Embodiments. It should be understood that the specific Embodiments described here are only used to explain the invention, and are not used to limit the invention.

The invention is realized by the following technical scheme:

Embodiment 1:

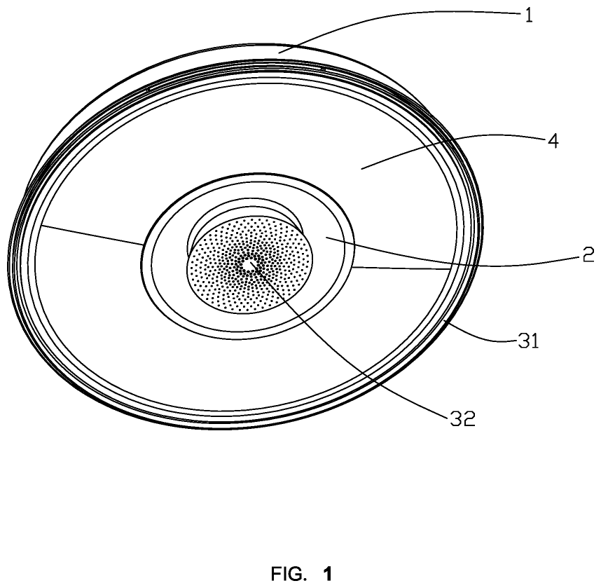

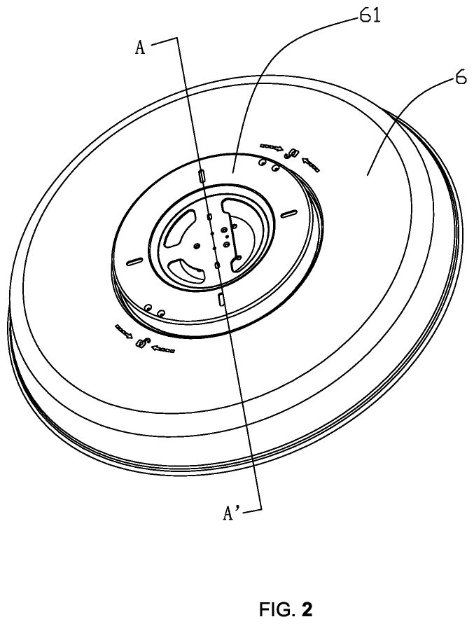

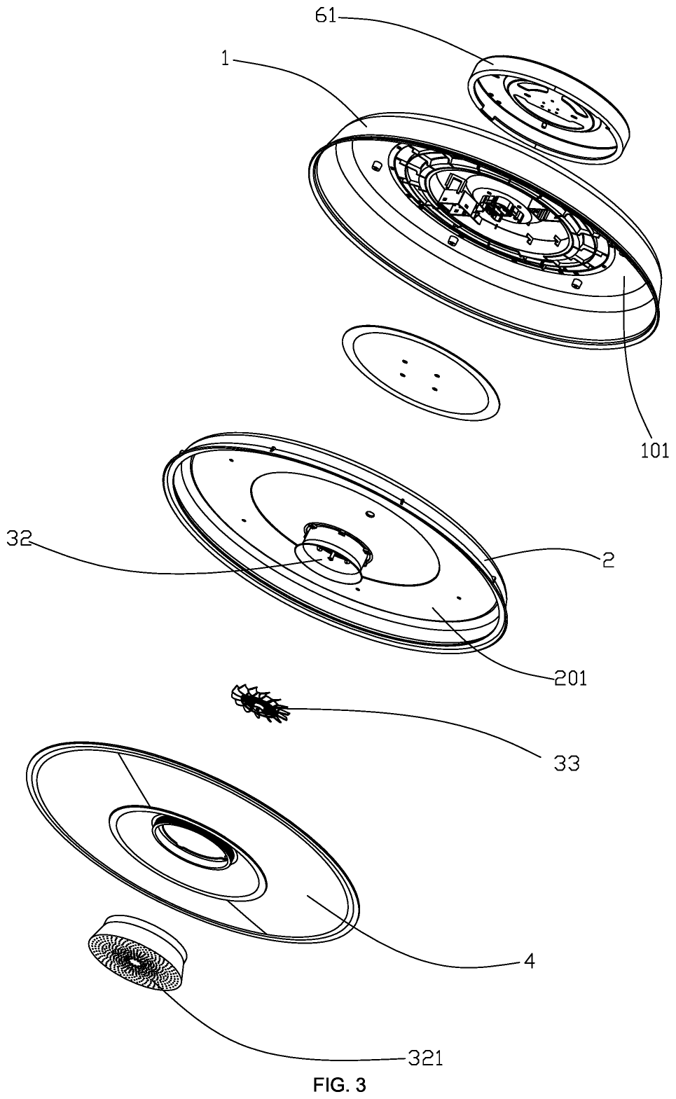

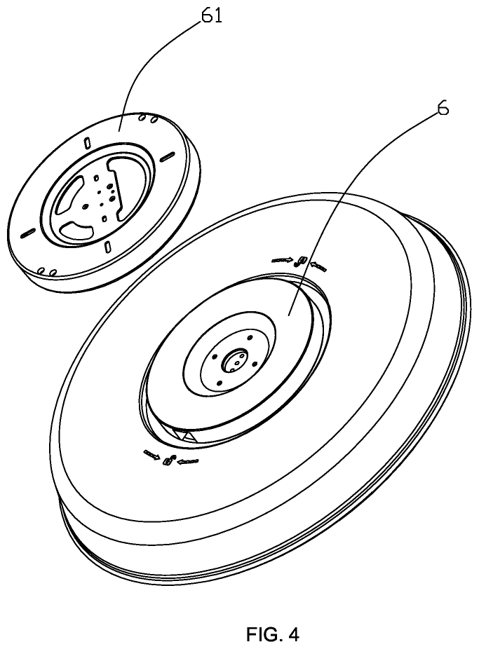

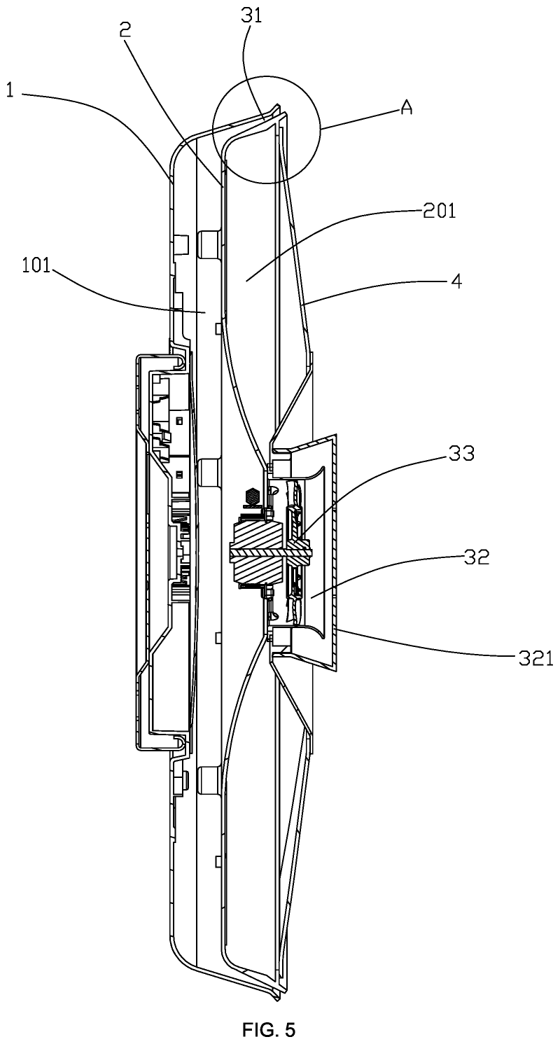

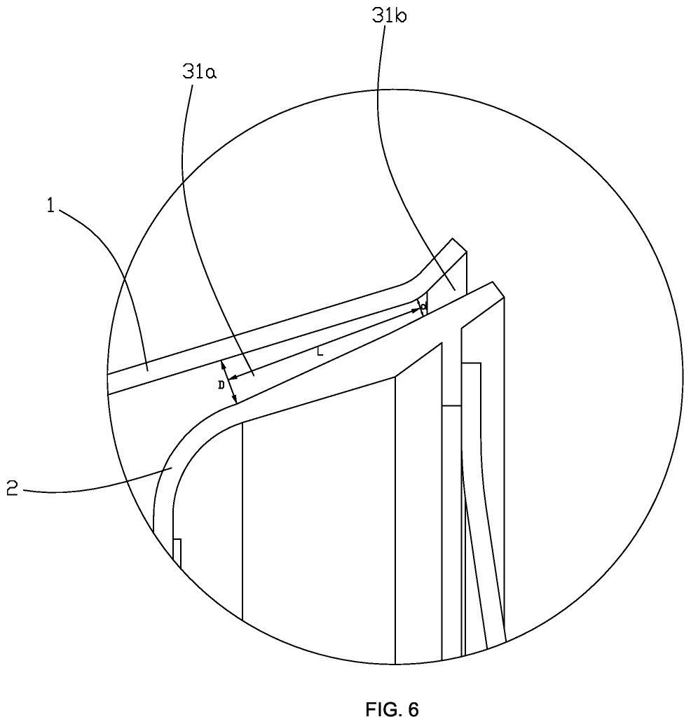

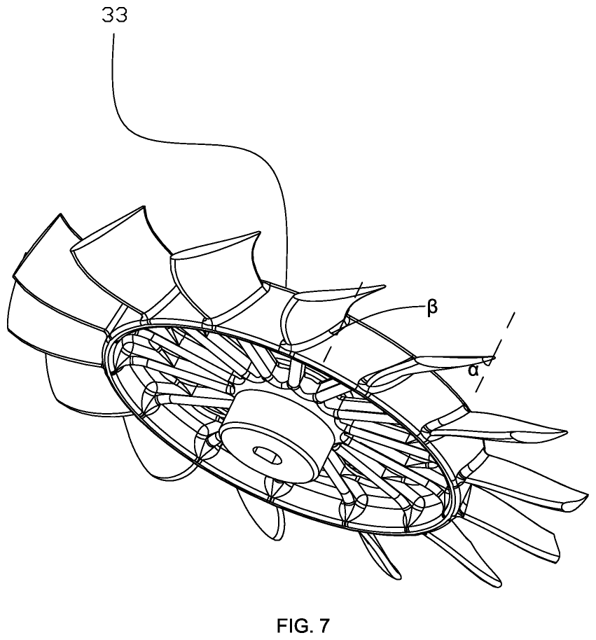

As shown in FIG. 1 to FIG. 7, a lighting device with a silent large-volume air duct structure comprises an outer shell 1 and an inner shell 2, wherein the inner shell 2 is provided with a light emitting part 4; the inner shell 2 is embedded and installed on the end face of the outer shell 1; and a gap between the outer periphery of the inner shell 2 and the inner side of the outer shell 1 forms an air outlet duct 31 which has an air outlet. The inner shell 2 is also provided with an air inlet 32 and an air suction part 33 arranged in the air inlet 32. The cross-sectional shape of the air outlet duct 31 includes an acceleration duct 31a whose width gradually decreases from inner to outer, and a trumpet-shaped opening 31b connected to the end of the acceleration duct 31a and connected with the outside.

The invention provides a lighting device with a silent large-volume air duct structure. By integrating the structure of a bladeless fan into the inner shell, it not only has the lighting function, but also meets the demand of air blowing, and at the same time, it also solves the problems that the fan lamp is large in size and easy to generate noise. Moreover, this product is not limited to be used in pendant lamps, can be used as wall lamps, ceiling lamps and other lamps, and can replace fans in more occasions. Moreover, the air outlet duct is optimized, and the air blown out through the acceleration duct and the trumpet-shaped opening has the characteristics of large air volume, wide angle and silence, which meets the needs of users.

Specifically, the trumpet-shaped opening 31b is arranged at an included angle with the acceleration air duct 31a. Specifically, the included angle between the trumpet-shaped opening 31b and the acceleration air duct 31a is 150° to 170°, so that the air blown out from the acceleration air duct can be redirected, and the angle of blowing out can be wider through the trumpet-shaped opening.

In addition, the width of the acceleration air duct 31a satisfies d=D−0.13 L;

Where, d is the width of the end of the acceleration air duct, D is the maximum width of the beginning of the acceleration air duct, and L is the length from the beginning to the end of the acceleration air duct. After several optimization iterations, the width and length of the acceleration air duct are constantly adjusted, and considering the actual manufacturing difficulty, the reasonable length and width range are finally obtained as follows:

The maximum width D of the beginning of the acceleration air duct 31a is 3˜6 mm. 4.8 mm is selected in this application.

The length L of the acceleration air duct 31a is 10˜20 mm. 13 mm is selected in this application.

With the above-mentioned reasonable size design, the slit-shaped acceleration air duct with narrower and narrower caliber is formed in the air outlet duct, so that the air blown out from the air outlet duct is sprayed at high speed, so that the air around the product flows to the high-speed jet. According to Bernoulli equation, it can be known that the static pressure of the high-speed air flow is lower than that of the surrounding air, so that the surrounding air flows to the high-speed jet, thus achieving the effect of flow doubling (the multiple of flow increase is related to the jet speed). Moreover, its air volume is larger than that of ordinary bladeless fans, and the mute effect is better.

Further, based on the central axis of the lighting device, the air outlet of the air outlet duct 31 is inclined outward, and the air flows out obliquely, thus enhancing the blowing range.

Furthermore, the lower end face of the outer shell 1 is provided with an upward concave inner cavity 101, the inner shell 2 is arranged in the inner cavity 101, and the lower end of the inner shell 2 is also provided with an upward concave cavity 201, and the light emitting part is arranged in the concave cavity 201. The light emitting part comprises a light emitting unit arranged in the concave cavity 201 and a light guide plate covering the lower end opening of the concave cavity 201. It combines the structure of bladeless fan on the lamp, which not only meets the functions of air outlet and lighting, but also solves the problems of difficult cleaning and potential safety hazard of ceiling fan lamp. Furthermore, in this scheme, the air outlet duct and the air inlet are located on the same end face, and are separated by the light emitting parts, which can be understood as air suction and air inlet from the direction of illumination, so that this product is not limited to be applied to pendant lamps, can be used as wall lamps, ceiling lamps and other lamps, and can replace fans in more occasions. This product can be used more widely and flexibly. In addition, there is a driver in the inner shell or the outer shell, through which the lighting function and the fan function can be started separately or simultaneously. The use of this product can be more flexible.

Moreover, in this scheme, the thickness of the outer shell 1 (that is, the distance from the upper end face to the lower end opening) is 45˜70 mm, which is light and thin, and the inner shell adopts embedded installation, which makes the overall size of the product small after the overall installation. And it can be seen from the attached drawings that this product is round and flat, and its overall structure is compact, light and thin.

In addition, after the inner shell is embedded and installed, it forms a gap with the inner cavity, thus forming a flow duct of air inlet-cavity gap-air outlet duct. Air is sucked from the air inlet from the outside by the air suction part, and is blown out from the air outlet duct after acceleration. By using the principle of bladeless fan and combining with the lighting fixture, the product has more complete functions, simple structure and small size.

Furthermore, the air inlet 32 is arranged in the middle of the inner shell 2 and connected with the inner cavity 101 of the outer shell 1. The air suction part 33 comprises an air suction fan arranged in the air inlet 32, and the air suction fan comprises a blade base 331 and a plurality of blades 332 uniformly distributed on the blade base 331 in a circumferential manner, and the included angle α between the blade tip and the central axis of the blade base is 33.5°˜37.3°, and the included angle β between the blade root and the central axis of the blade base is 52°˜58°. By improving the blade root mounting angle and blade tip mounting angle on the blade base, compared with the traditional fan blade design, under the condition of the same size and the same electric power rate input, the blade design has the characteristics of small size, light weight, high efficiency and large air flow at the blade, which makes the fan blade assembly widely used in various ventilation equipment with simple structure, small size, light weight and large air flow.

Specifically, the blade tip mounting angle α: 33.5°˜37.3°; Take 35° in the patent. Root mounting angle β: 52°˜58; Take 55° in the patent. With this blade design, the fan efficiency can be improved by at least 5% under the condition of the same size and the same electric power input. Or, under the condition of the same size and electric power input, the air volume of the new configuration fan can be increased by at least 5% compared with that of the traditional power fan.

In addition, air inlet 32 is provided with a dust-proof cover 321. It is beneficial to prevent external dust and particles from entering the interior of the product, causing problems such as blockage and damage, etc.. In addition, a filter device for filtering impurities in the air or refreshing air can be set to filter the air and make the blown air flow fresher.

In this scheme, the upper end face of the outer shell 1 is also provided with a mounting part 6, and the mounting part 6 is connected with a mounting seat 61 for fixedly connecting to the outside, and the mounting seat 61 is detachably connected to the mounting part 6. The mounting seat is used to fix on outside connectors, such as walls, beams and columns, etc. In this scheme, the mounting seat 61 is detachably connected to the mounting part 6, and different mounting seats can be replaced according to different connection requirements, so that the application range of the product is wider.

The invention provides a lighting device with a silent large-volume air duct structure. After the inner shell is embedded and installed, it forms a gap with the inner cavity, thus forming a flow duct of air inlet-cavity gap-air outlet duct. Air is sucked from the air inlet by air suction parts from the outside and blown out from the air outlet duct after acceleration. By using the principle of bladeless fan, and combined with lighting fixtures, the product not only has the lighting function, but also meets the demand of air blowing, and at the same time, it also solves the problems that the fan lamp is large in size and easy to generate noise. Moreover, this product is not limited to be used in pendant lamps, can be used as wall lamps, ceiling lamps and other lamps, and can replace fans in more occasions. Moreover, the air outlet duct is optimized, and the air blown out through the acceleration duct and the trumpet-shaped opening has the characteristics of large air volume, wide angle and silence, which meets the needs of users.

Embodiment 2:

The difference between Embodiment 2 and Embodiment 1 is that the installation position of air inlet 32 is different, and the air inlet 32 is changed to the side air inlet mode; In Embodiment 1, the air inlet is arranged at the center of the inner shell 2. If the lighting device is ceiling lamp or pendant lamp structure, Embodiment 1 is a mode of air inlet from the bottom, which draws air from the bottom air inlet, flows through the cavity gap and then flows out from the air outlet duct. However, in Embodiment 2, the inner shell 2 is still embedded in the outer shell 1, and the air outlet duct 31 is formed between the inner shell 2 and the outer shell 1. However, in Embodiment 2, the position of the air inlet 32 is changed, and the air inlet 32 can be arranged on the outer shell 1.

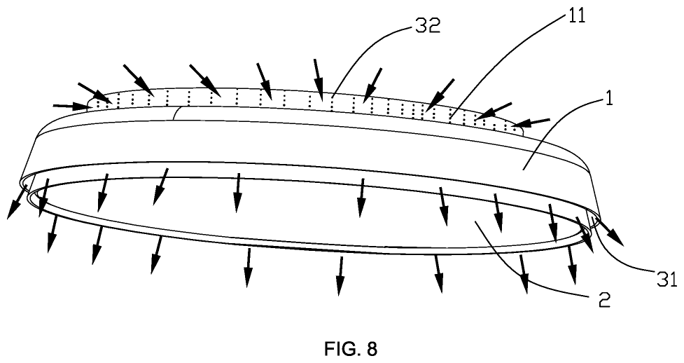

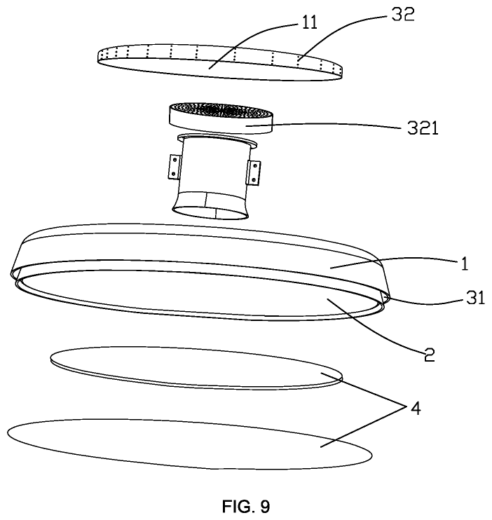

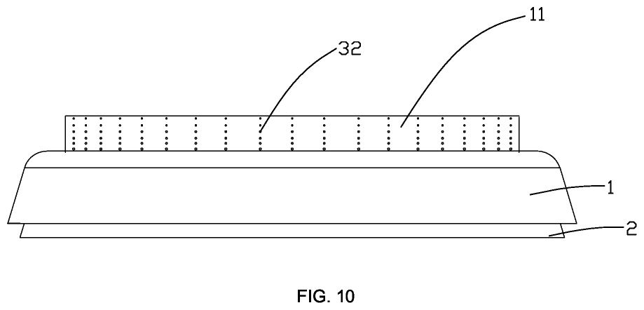

Specifically, as shown in FIG. 8-10, the inner shell 2 is embedded and installed in the outer shell 1, and the air outlet duct 31 is formed between the outer peripheral wall of the inner shell 2 and the inner peripheral wall of the outer shell 1. The outer shell 1 is provided with an air inlet 32, and an air suction part 33 is provided corresponding to the air inlet 32, and the air suction part 33 still contains an air suction fan.

The upper end of the outer shell 1 is provided with a detachable mounting part 11, and the air inlet 32 is arranged on the peripheral side of the mounting part 11, and a detachable dust-proof cover 321 is also arranged at the air inlet 32. The air inlet 32 is arranged on the rear side of the outer shell 1 and takes in air from the side. Even if the lighting device is directly installed on the top wall of the room, the air suction of air inlet 32 on the side will not be affected.

In Embodiment 2, because the air inlet 32 is changed to be arranged on the outer shell 1, there is no need to reserve the position of the air inlet on the inner shell 2, so the area of the light emitting part 4 can be increased, and the light emitting part 4 can also facilitate the assembly of the light emitting part, thus improving the assembly and production efficiency.

Embodiment 3:

The difference between Embodiment 3 and Embodiment 2 is that the air inlet 32 is set to the rear air inlet mode.

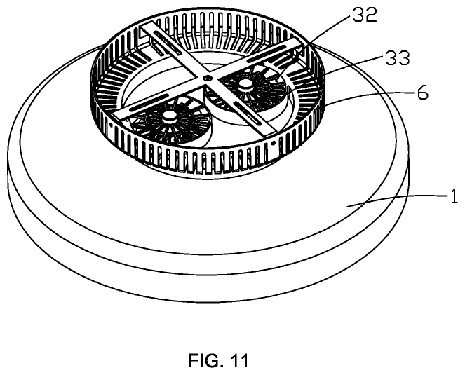

As shown in FIG. 11, the inner shell 2 is embedded and installed in the outer shell 1, and the air outlet duct 31 is formed between the outer peripheral wall of the inner shell 2 and the inner peripheral wall of the outer shell 1. The air inlet 32 is arranged at the top of the outer shell 1 and connected with the air outlet duct 31, and the air suction part 33 is installed in the cavity gap corresponding to the air inlet 32.

If the lighting device is designed as a ceiling lamp, the specific structure of the mounting part 6 in Embodiment 1 needs to be changed, and the mounting part 6 is changed into a mesh-like structure, which protrudes upward from the top of the outer shell 1; Through the mounting part 6, the air inlet space is formed between the top wall of the outer shell 1 and the ceiling plane where it is installed, and the air flow can be smoothly sucked from the air inlet 32.

If the lighting device is designed as a pendant lamp, the air inlet 32 can be directly added to the outer shell 1, and then the whole lighting device can be hoisted and installed through the pendant lamp bracket.

The light emitting part 4 of the above-mentioned Embodiment 1, Embodiment 2 and Embodiment 3 are all arranged in the inner shell 2. In other ways, the light emitting part 4 can be arranged in a ring shape, or they can be installed to the outer peripheral wall of the outer shell 1, and a purification structure can be added in the inner shell 2 correspondingly.

As described above, it is one or more embodiments provided in combination with the specific content, and it is not considered that the specific embodiment of the invention is only limited to these descriptions. Any similarity or approximation with the method and structure of the invention, or some technical deduction or replacement on the premise of the concept of the invention should be regarded as the protection scope of the invention.

What is claimed is:

1. The lighting device with a silent large-volume air duct structure, comprises an outer shell (1) and an inner shell (2), wherein a light emitting part (4) is arranged on the outer shell (1) or the inner shell (2), and it is characterized in that the inner shell (2) is embedded and installed on the end face of the outer shell (1), and a gap between the outer periphery of the inner shell (2) and the inner side of the outer shell (1) forms an air outlet duct (31). The outer shell (1) or the inner shell (2) is also provided with an air inlet (32), the air inlet (32) is connected with an air outlet duct (31), a air suction part (33) is arranged corresponding to the air inlet (32), and the cross-sectional shape of the air outlet duct (31) includes an acceleration air duct (31a) whose width gradually decreases from inner to outer, and a trumpet-shaped opening (31b) connected at the end of the acceleration air duct (31a) and connected with the outside.

2. The lighting device with a silent large-volume air duct structure according to claim 1, characterized in that the trumpet-shaped opening (31b) is arranged at an included angle with the acceleration air duct (31a).

3. The lighting device with a silent large-volume air duct structure according to claim 2, characterized in that the included angle between the trumpet-shaped opening (31b) and the acceleration air duct (31a) is 150° to 170°.

4. The lighting device with a silent large-volume air duct structure according to claim 1, characterized in that the width of the acceleration air duct (31a) satisfies d=D−0.13 L;
Where, d is the width of the end of the acceleration air duct, D is the maximum width of the beginning of the acceleration air duct, and L is the length from the beginning to the end of the acceleration air duct.

5. The lighting device with a silent large-volume air duct structure according to claim 4, characterized in that the maximum width D of the beginning of the acceleration air duct (31a) is 3˜6 mm.

6. The lighting device with a silent large-volume air duct structure according to claim 4, characterized in that the length L of the acceleration air duct (31a) is 10˜20 mm.

7. The lighting device with a silent large-volume air duct structure according to claim 2, characterized in that the light emitting part (4) is installed in the inner shell (2); Or the light emitting part (4) is installed on the outer wall of the outer shell (1).

8. The lighting device with a silent large-volume air duct structure according to claim 7, characterized in that the lower end face of the outer shell (1) is provided with an upward concave inner cavity (101), the inner shell (2) is arranged in the inner cavity (101), the lower end of the inner shell (2) is also provided with an upward concave cavity (201), and the light emitting part is arranged in the concave cavity (201). The light emitting part comprises a light emitting unit arranged in the concave cavity (201) and a light guide plate covering the lower end opening of the concave cavity (201).

9. The lighting device with a silent large-volume air duct structure according to claim 7, characterized in that the air inlet (32) is arranged in the middle of the inner shell (2) and connected with the inner cavity (101) of the outer shell (1); Or the air inlet (32) is arranged in the middle of the outer shell (1) and connected with the inner cavity (101) of the outer shell (1).

10. The lighting device with a silent large-volume air duct structure according to claim 9, characterized in that the air suction part (33) comprises an air suction fan arranged in the air inlet (32), and the air suction fan comprises a blade base (331) and a plurality of blades (332) uniformly distributed on the blade base (331) in a circumferential manner, and the included angle α between the blade tip and the central axis of the blade base is 33.5°˜37.3 °, and the included angle β between the blade root and the central axis of the blade base is 52°˜58°.

11. The lighting device with a silent large-volume air duct structure according to claim 10, characterized in that the upper end face of the outer shell (1) is provided with a mounting part (6), and the mounting part (6) is connected with a mounting seat (61) for fixedly connecting to the outside, and the mounting seat (61) is detachably connected to the mounting part (6).

12. The lighting device with a silent large-volume air duct structure according to claim 11, characterized in that the air inlet (32) is provided with a dust-proof cover (321).
